(19) United States
(12) Patent Application Publication
(10) Pub. No.: US 2025/0216955 A1
(43) Pub. Date: Jul. 3, 2025

(54) SYSTEM AND METHOD FOR BUILDING COMPUTER APPLICATIONS USING LARGE LANGUAGE MODEL CHATBOTS

(71) Applicant: Cvent, inc., Tysons Corner, VA (US)

(72) Inventors: Nathaniel CARON, Fredericton (CA); Xuan Yuan, Fredericton (CA); Alexandre Carvalho, Fredericton (CA)

(73) Assignee: Cvent, inc., Tysons Corner, VA (US)

(21) Appl. No.: 18/397,462

(22) Filed: Dec. 27, 2023

(51) Int. Cl. G06F 3/02; G06F 40/40; H04L 51/02

(52) U.S. Cl. CPC G06F 3/0227; G06F 40/40; H04L 51/02

(57) ABSTRACT

Systems, methods, and computer-readable storage media for building computer applications, and more specifically to building computer applications where the commands and functions of the computer applications are determined using a Large Language Model (LLM) chatbot. A system can receive a question, and determine the context of the question. The system can then transmit the question with the context to a large language model chatbot. The system can then receive, at the computer system from the large language model chatbot based on the question and the context, at least one function. The system can execute the function(s), and send the result back to the chatbot. This process may repeat, with the end result being an answer to the original question, where the answer is generated by the chatbot.

### BACKGROUND

### 1. Technical Field

The present disclosure relates to building computer applications, and more specifically to building computer applications where the commands and functions of the computer applications are determined using a Large Language Model (LLM) chatbot.

### 2. Introduction

Computer programs and applications rely on commands and functions which are executed by computer processors. Selecting which commands and functions to use, and the sequence in which to execute those commands and functions, is the role of a computer engineer or computer programmer. A Large Language Model (LLM) is a type of Artificial Intelligence (AI) that has been trained on vast amounts of text to understand existing content and generate original content. LLMs can encompass a variety of architectures, including Transformers, Recurrent Neural Networks (RNNs), and Convolutional Neural Networks (CNNs). A Generative Pre-Trained Transformer (GPT) is a type of LLM based on the Transformer architecture, pre-trained on large sets of text, and are able to generate novel content based on received prompts and the training data used. A chatbot can be used with a GPT system to receive prompts and to output responses of the GPT.

### SUMMARY

Additional features and advantages of the disclosure will be set forth in the description that follows, and in part will be understood from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media which provide a technical solution to the technical problem described. A method for performing the concepts disclosed herein can include: receiving, at a computer system from a terminal, a question; determining, via at least one processor of the computer system, a context of the question; transmitting, from the computer system to a large language model chatbot, the question with the context; receiving, at the computer system from the large language model chatbot based on the question and the context, at least one function; executing, at the computer system, the at least one function, resulting in at least one function result; transmitting, from the computer system to the large language model chatbot, the at least one function result; receiving, at the computer system from the large language model chatbot, a natural language answer to the question based on the at least one function result; and transmitting, from the computer system to the terminal, the natural language answer.

A system configured to perform the concepts disclosed herein can include: at least one processor; and a non-transitory computer-readable storage medium having instructions stored which, when executed by the at least one processor, cause the at least one processor to perform operations comprising: receiving, from a terminal, a question; determining a context of the question; transmitting, to a large language model chatbot, the question with the context; receiving, from the large language model chatbot based on the question and the context, at least one function; executing the at least one function, resulting in at least one function result; transmitting, to the large language model chatbot, the at least one function result; receiving, from the large language model chatbot, a natural language answer to the question based on the at least one function result; and transmitting, to the terminal, the natural language answer.

A non-transitory computer-readable storage medium configured as disclosed herein can have instructions stored which, when executed by at least one processor, cause the at least one processor to perform operations which include: receiving, from a terminal, a question determining a context of the question; transmitting, to a large language model chatbot, the question with the context; receiving, from the large language model chatbot based on the question and the context, at least one function; executing the at least one function, resulting in at least one function result; transmitting, to the large language model chatbot, the at least one function result; receiving, from the large language model chatbot, a natural language answer to the question based on the at least one function result; and transmitting, to the terminal, the natural language answer.

### BRIEF DESCRIPTION OF THE DRAWINGS

FIG. 1 illustrates an example system embodiment;

FIG. 2 illustrates an example analogy of the system as shown in FIG. 1;

FIG. 3 illustrates an example flowchart of actions taken by the system;

FIG. 4 illustrates an example of data transmissions by the system;

FIG. 5 illustrates an example flowchart of system processes;

FIG. 6 illustrates an example of ordered system processes;

FIG. 7 illustrates an example method embodiment; and

FIG. 8 illustrates an example computer system.

### DETAILED DESCRIPTION

Various embodiments of the disclosure are described in detail below. While specific implementations are described, this is done for illustration purposes only. Other components and configurations may be used without parting from the spirit and scope of the disclosure.

Systems configured as disclosed herein may be considered a service assistant, communicating with additional systems and databases to resolve questions or concerns of users, or to build new computer programs/applications. To do so, the system has access to a database of available computer functions and an LLM chatbot, such as (but not limited to) OPENAI's CHATGPT, MICROSOFT's BING, X's GROK, METTA's LLAMA 2, ANTHROPIC's CLAUDE, etc., and the system provides a list of the available computer functions to the LLM chatbot. The user then asks the system a question (or presents an issue to be resolved), and the system forwards that request to the LLM chatbot. The LLM chatbot then responds to the request with a list of one or more functions which should be called. The system receives the list of one or more functions and executes those functions. The result of those functions is then passed back to the LLM chatbot, which interprets the results and provides the system with a natural language response. The system then passes the natural language response back to the user.

The question provided by the user to the system can be, for example, a request to solve a certain problem or a request for the system to provide a specific solution. Non-limiting examples of a problem/request could be for the system to correct a coding issue, for the system to provide a way to access specific information, a way for the system to assign a task to an individual, providing a way to update specific information, a request to act on behalf of a user (e.g., send an email, write a text), etc.

Preferably, before the system forwards the request to the LLM chatbot, the system processes the request, identifying the topic(s) and/or context of the request. Based on the topic(s) and/or context of the request, the system can identify embeddings (i.e., vectors, or numbers describing how the request relates to one or more categories) which correspond to the request. Preferably, the use of embeddings narrows down the list of possible functions and therefore reduces the request size. The embeddings can be forwarded to the LLM chatbot with the request, allowing the LLM chatbot greater clarity regarding the request. To identify the embeddings, the system can perform natural language processing on the request, thereby identifying keywords. In some configurations, the identified keywords can be vectorized by the system using WORD2VEC or other algorithms which convert keywords into embeddings (aka vectors). Alternatively, the system can look up embeddings which correspond to the keywords (i.e., a database stores a list of keywords and associated embeddings, and the system performs a comparison to identify the corresponding embedding). In yet other configurations, the system can use a hybrid approach (thereby saving computational power, where possible), where the system attempts to look up embeddings if they exist in the database, but computing the embeddings if they do not, then saving any newly created embeddings in a database for future lookup. In some configurations, based on the embeddings, only the top available functions will be passed onto the LLM chatbot, where the ranking is based on a similarity of the embedding to the functions.

When the LLM chatbot receives the list of available commands/functions (hereafter jointly referred to as “functions”) from the system, followed by the request, the LLM chatbot can determine which of the functions can be used by the system to satisfy the request. For example, if the system has available functions A, B, and C, the LLM chatbot can analyze the request, compare the request to the available functions, and suggest (as the output) that the system use one or more of functions A, B, and C to satisfy the request. Such suggestion can include the inputs associated with a given function. In addition, if more than one of the functions is required, the LLM chatbot can provide the order in which the functions should be executed.

The system, upon receiving the functions from the LLM (along with any required inputs and/or order of operations), can then execute the functions. If necessary, the system can retrieve the functions and/or input data needed for those functions from a database or other storage media. For example, in some configurations, the system can use a data query language, such as (but not limited to) GRAPHQL, to enable declarative data fetching when the system knows exactly what data it needs from an Application Programming Interface (API), then use the fetched data as input to one or more of the functions. Likewise, in some configurations, the system can make use of a universal API to retrieve data, or even other chatbots to obtain the required data. In addition, the system can make use of subscriptions to update the application state in real time using the function and inputs recommended by the chatbot.

After the system executes the functions and generates associated results, those results can be sent back to the LLM chatbot, such that the LLM chatbot uses the results of the functions to generate a natural language response to the initial request. The LLM chatbot will only generate a natural language response if it deems that it has enough information to answer the initial request. Otherwise, it would send the system another request for function call(s) to continue to accumulate the context it needs to answer that original request. In some cases, the LLM chatbot may not remember or otherwise be configured to continue the previous conversation (that resulted in the functions). In such configurations, the system can store the initial conversation in a database while retrieving and/or executing the functions, such that when the function results are ready to be analyzed by the LLM chatbot, the initial conversation can be retrieved. The system can, for example, continue a conversation by providing the conversation identification (ID) to the chatbot when making a request. If the conversation ID is omitted, then the chatbot can treat the request as a new conversation. Preferably, the system stores the conversation ID in memory and in a database to make sure it can be provided when making requests to the chatbot unless it is a new conversation or the user indicates they want to restart the conversation or refresh the page.

Upon receiving the natural language response, which is an answer to the initial request, the system can forward the natural language response to the user. Alternatively, if the initial request was for the system to build a program, application, or piece of code (collectively “code”), the system can respond to the user's request with the code and the natural language response produced by the LLM chatbot can be “Here is the requested code,” or something similar.

Consider the following example of using the system to update data. A user requests that the system change the color palette being used by an application. The system executes natural language processing, identifying the keywords as “change color palette”. The system can convert those words to an embedding, then identify which available functions are closest to the embedding (e.g., using a distance measurement based on the embedding or through other measures). The closest available functions are sent to the LLM chatbot with the original request, and the LLM chatbot identifies which of the closest available functions to execute, the necessary inputs for those functions (if any), and the order in which they are to be executed. The system can then retrieve those functions from a database, obtain the input data using APIs (if needed), and execute the functions to change the data. In this case, the system can execute functions to change the color palette, and API calls may identify the new colors to be used. The results can then be forwarded to the LLM chatbot which, in this case, produces text reading, “Palette updated. Are you satisfied with the new palette?” That text can be received by the system from the LLM chatbot, and forwarded to the user.

Some of the technical improvements a system configured as described here provides include: (1) Reduced bandwidth—by (a) sending only a partial list of available functions, rather than all lists, the amount of data communicated to the chatbot is reduced. While the chatbot still requires information about available functions, performing preliminary processing to reduce the amount of data communicated to the chatbot represents a bandwidth reduction; and (b) by sending embeddings describing available and related functions to the chatbot, rather than text/code of the functions, the amount of data is further reduced. Such embeddings can further include context, keywords, and/or topics of the request. Please note that in some cases the embeddings are extremely long sets of numbers, and could potentially be longer than the natural language data used to generate the embeddings. In such cases the embedding provides additional security over the natural language alternative. (2) Diffused processing—by using the LLM chatbot to process the request (and any context/topics/embeddings provided) in view of the available functions, while the system itself executes the functions and builds the application as directed by the LLM chatbot, the system divides the required processing for the overall process into specialties which operate more efficiently.

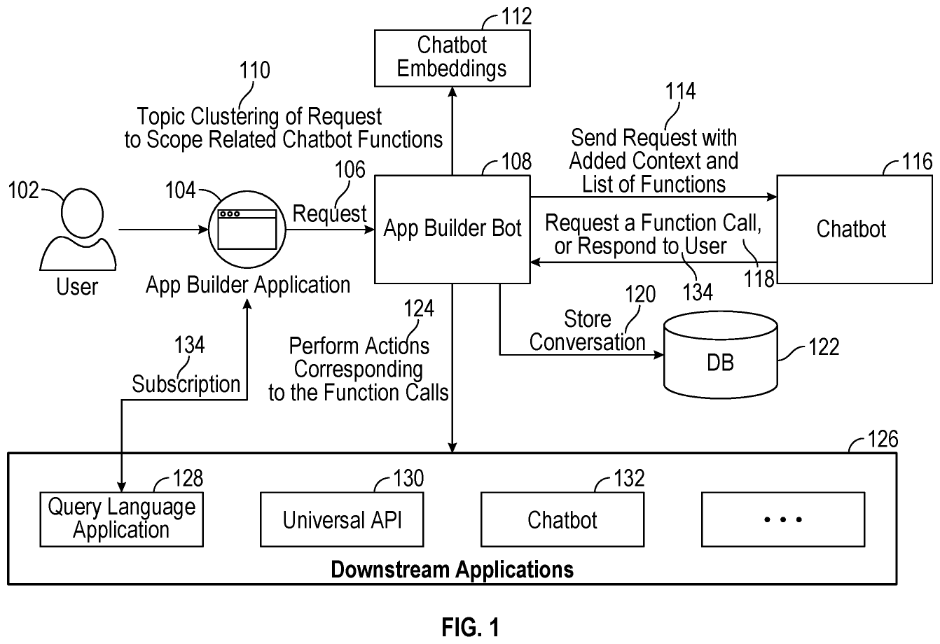

FIG. 1 illustrates an example system embodiment. In this example, a user 102 is interacting with an “App Builder Bot” 108 via a user interface, the App Builder Application 104. Through the App Builder Application 104, the user 102 makes a request 106, which the App Builder Bot 108 receives. The App Builder Bot 108 can process the request, performing (for example) topic clustering 110 of the request 106 to scope (identify) related and available App Builder Bot 108 functions. Alternatively, the App Builder Bot 108 can perform natural language processing to identify keywords or other contexts/topics of the request 106. Depending on the configuration, the related App Builder bot 108 functions, topics, and/or contexts can be stored in a database as chatbot embeddings 112 for the chatbot 116.

The App Builder Bot 108 uses the embeddings to filter out the list of available functions, such that role of filtering falls on app builder 108, not on the LLM chatbot 114, and sends the remaining functions to the chatbot 114. Alternatively (in other configurations), the App Builder Bot 108 can send the request 106 with added context and/or the list of related and available functions 114 (preferably, though not necessarily, as embeddings) to the chatbot 116. The chatbot 116 (which uses a trained LLM) processes the request with the added context and list of available functions 114, then returns which function(s) to call 118 and in what order to the App Builder Bot 108. The App Builder Bot 108 can then store the conversation 120 with the chatbot 116 in a database 122, and perform actions corresponding to the function calls 124. Examples of such actions can include executing the functions specified in the response 118 from the chatbot 116, or calling additional downstream applications 126 (such as, but not limited to, query language applications 128 (with or without a subscription 134), universal APIs 130, additional chatbots 132, etc.). If additional context/data is needed, the process of communications to and from the chatbot 114 can continue until sufficient context/data is obtained. Upon completing the functions specified by the chatbot 116, the App Builder Bot 108 can send the results to the chatbot 116, and the chatbot can respond to the user 134 request with text which is received by the App Builder Bot 108. The App Builder Bot 108 can then respond to the original request 106 using the response 134 generated by the chatbot 116.

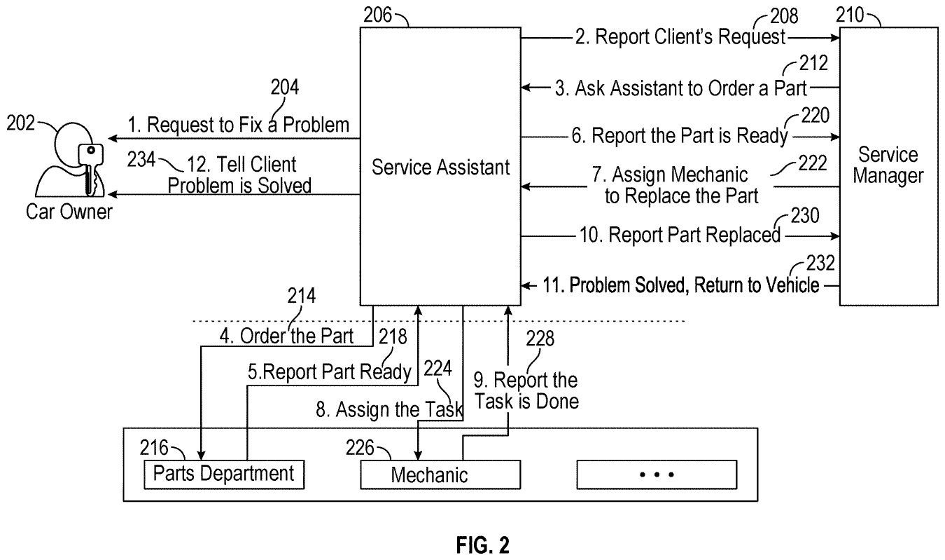

FIG. 2 illustrates an example analogy of the system illustrated in FIG. 1. In this example, the user 202 (a Car Owner) makes a request 204 to a service assistant 206 to fix a problem. The a service assistant 206 receives the request 204, processes the request 204, and reports the request 208 to a service manager 210, who asks the service assistant 206 to order a part 212. The service assistant orders the part 214 from the parts department 216, who then reports when the part is ready 218. The service assistant 206 reports back to the service manager 210 that the part is ready 220, and the service manager 210 assigns a mechanic 226 to replace the part 222. The assignment 222 passes is conveyed 224 by the service assistant 206 to the mechanic 226, and the mechanic 226 reports 228 to the service assistant 206 when the task is done. The service assistant 206 reports back 230 to the service manager that the part is replaced, and the service manager 210 determines that the problem is solved and instructs the vehicle's return 232. The service assistant 206 then tells the client 202 that the problem is solved 234. In this example, the service assistant is the App Builder Bot 108 of FIG. 1, while the service manager 210 represents the chatbot 116, working together to perform specific tasks.

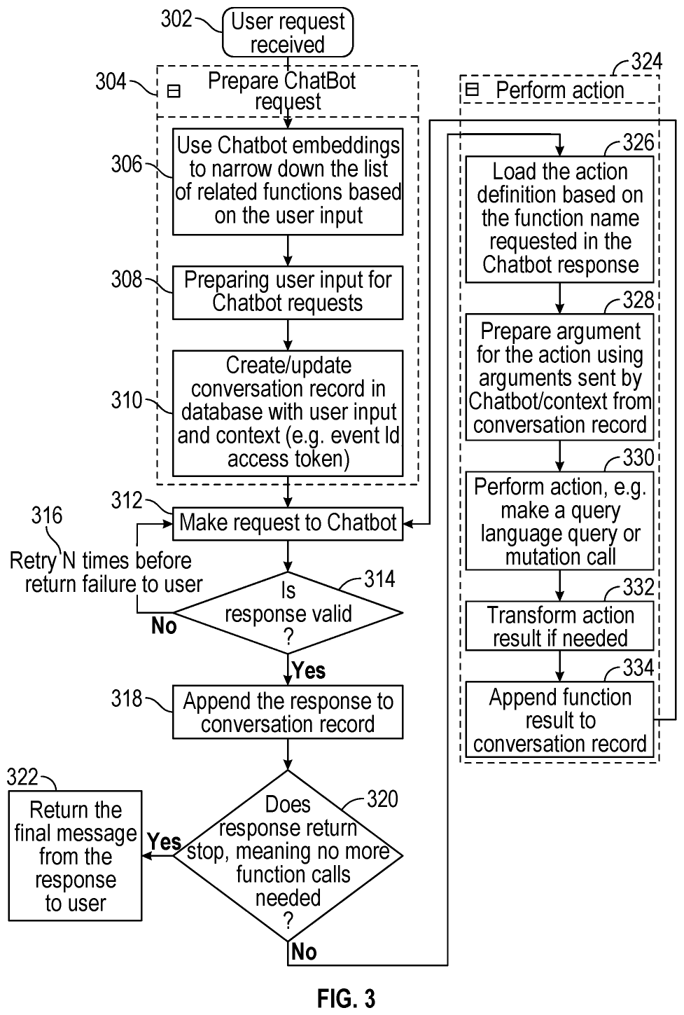

FIG. 3 illustrates an example flowchart of actions taken by the system. In this example, a user request is received 302 (e.g., by the system), which prepares a chatbot request 304. Preparing a chatbot request 304 can include one or more of: 1) The system using chatbot embeddings to narrow down the list of related functions based on the user input 306; 2) The system preparing 308 or otherwise modifying the user input/request to comply with chatbot request/input requirements; and/or 3) The system creating/updating a conversation database with user input and context (e.g., an event ID, an access token, etc.) 310. The system can then make the request to the chatbot 312, and the system can receive a response from the chatbot. If the response is not a valid response, the system can retry a predetermined number of times “N” before telling the user that a failure has occurred 316. If the response is valid, the system can append the response to the conversation record 318. The system can also determine if the response from the chatbot contains a “stop” 320, which means that the response also contains the natural language message for the original request. If the response returns a “stop”, this can mean that no additional functions calls are needed, and the system can return the final message from the response to the user 322. If the response does not contain a “stop,” then the system needs to perform one or more actions 324.

The actions are performed by loading the action definition based on the function name requested in the chatbot response 326. The system then prepares the argument(s) for the action using arguments sent by the chatbot and/or context from the conversation record 328. The system then performs the action, e.g., making a query language query, a mutation call, executing a function or command, etc. 330. The system can transform an action result if needed 332, and append the function result to the conversation record 334. The system can then make another request to the chatbot 312 based on the appended function result 334, and the process can continue until the “stop” is detected in the chatbot response 320.

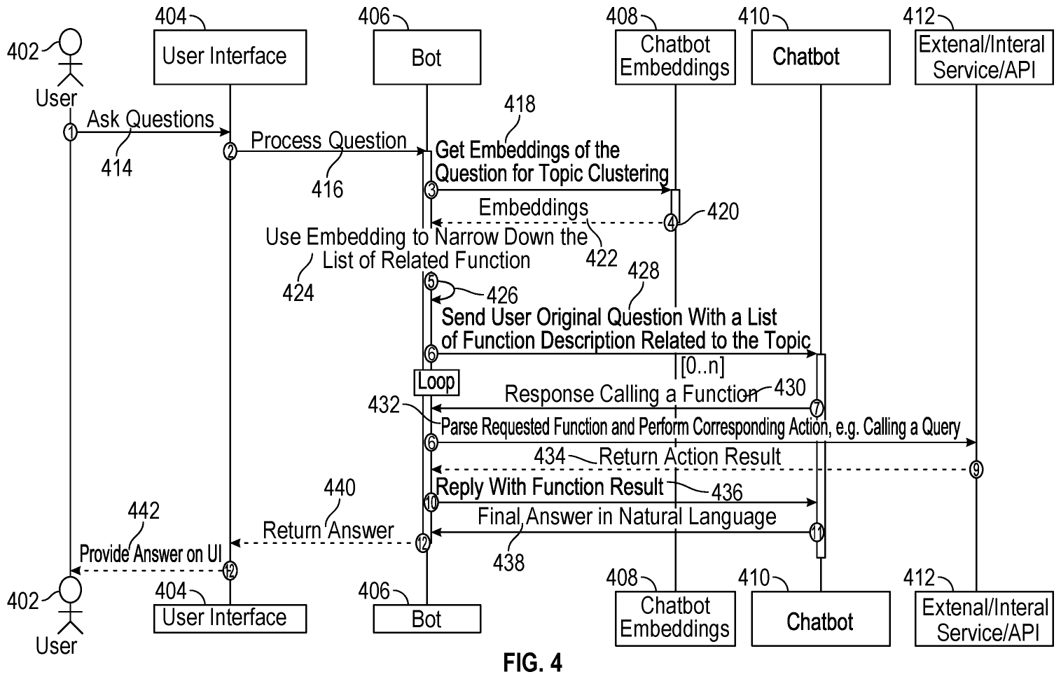

FIG. 4 illustrates an example of data transmissions by the system. In this example, there are six different processing points: a user 402, the User Interface 404, the bot 406, the chatbot embeddings 408, the chatbot 410, and the External/Internal Service/API 412. In this example, the user 402 asks a question 414 (in other examples, the user 402 could make a request), and the User Interface 404 processes the question 416 and forwards the processed question to the bot 406. The bot 406 gets embeddings for the question for topic clustering 418, and retrieves embeddings 420 from the chatbot embeddings 408. The retrieved embeddings 422 are used by the bot 406 to narrow down the list of related functions 424 (the arrow 426 indicating that the Bot 406 will take on the operation of narrowing down the list of functions), and the bot 406 sends 428 the original question with a list of function descriptions that relate to the topic of the question to the chatbot 410. The chatbot 410 responds to the bot 406 with a list of one or more functions along with their respective parameters that should be executed by the bot 406. More specifically, the chatbot 410 responds to the bot 406 with a list of one or more functions along with their respective parameters that should be executed by bot 406. The bot 406 parses the received function(s) within the response from the chatbot 410 and performs the corresponding action (e.g., calling a query) 432, which can be accomplished by calling on one or more additional applications using the External/Internal Services/API 412. In this example, the External/Internal Services/API 412 returns the action result 434 to the bot 406, which responds to the chatbot 410 with the function result 436, and the chatbot generates a final answer to the question in natural language 438. The bot 406 then passes the answer 440 back to the User Interface 404, which provides the answer 442 to the user 402.

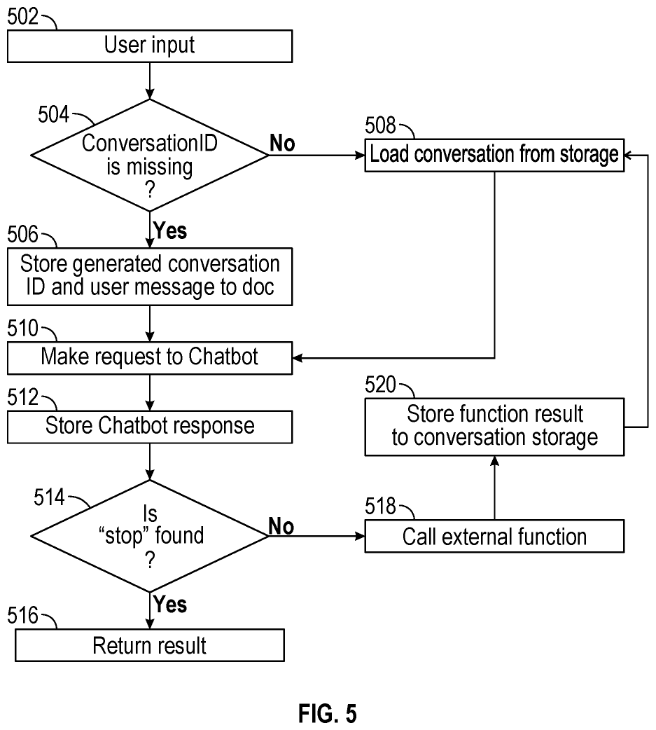

FIG. 5 illustrates an example flowchart of system processes. In this example, the system receives user input 502, and the system determines if a conversation identification (conversationID) is missing. If the conversationID is not found, the system stores 506 a generated conversationID and a user message to a document. That is, the system can save the conversation ID in memory as well as other forms of the conversation (e.g., a distributed JSON document or other format, which may or may not be open source, stored to a database (cloud-based or otherwise)). When a certain user starts a conversation, the system can check if there is an ongoing conversation ID stored for that user and event. At that point, or if the conversationID is present and the system can load a conversation from storage 508, the system makes a request to the chatbot 510, and the system stores the chatbot response 512. The system then determines if the chatbot response contains a stop. If so, the system returns the result 516. If not, the system can call an external function 518 (or execute a stored function), and store the function result to the conversation storage 520. This conversation storage can then be used in the future to load conversations 508 based on user input 502.

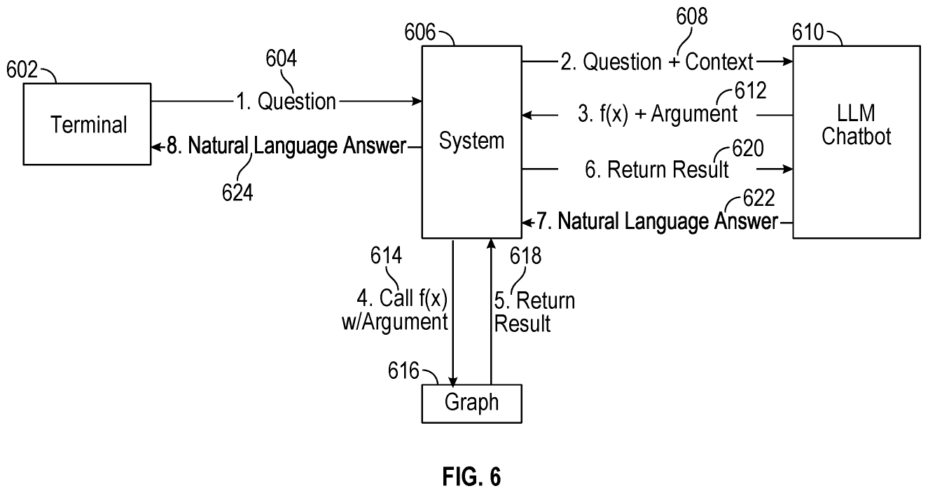

FIG. 6 illustrates an example of ordered system processes. In this example, a terminal 602 is used to generate a question 604, which is received by the system 606. The system adds context, identifies available functions, embeddings for those functions, etc. The system 606 then sends the question and context 608 (and/or additional data, such as embeddings) to an LLM chatbot 610, which responds with one or more functions and arguments 612. The system 606 calls the one or more functions with the arguments 614 using a graph 616. The graph can be a query language and server to interface with micro-services, and can be used to talk to micro-services and create subscriptions. The graph can return the function results 618 to the system 606. The system 606 sends the results 620 to the LLM chatbot 610, which provides a response to the question 604 based on the results 620 in the form of a Natural Language Answer 622 to the system 606. The system 606 then sends the natural language answer 624 to the terminal 602 as an answer to the question 604.

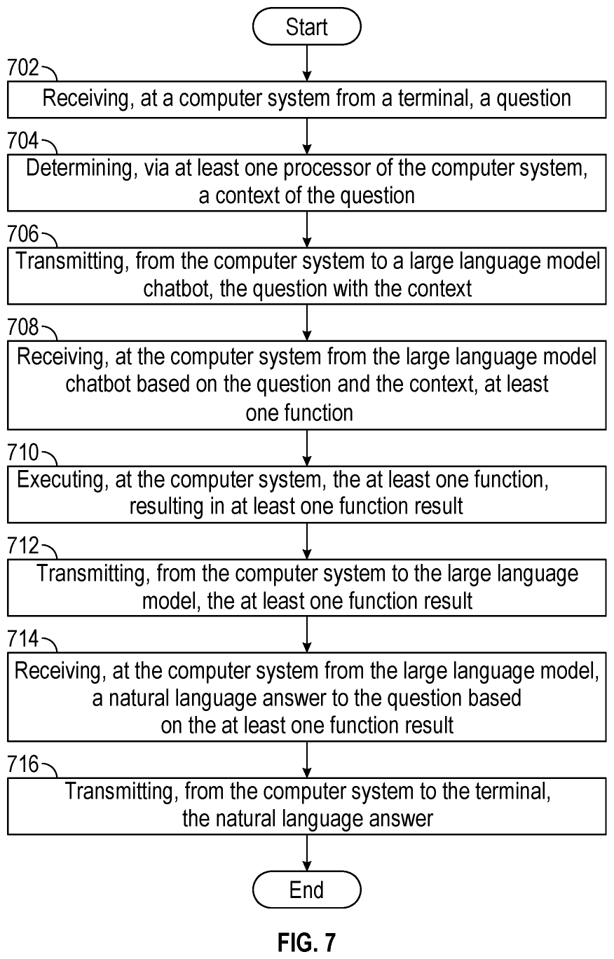

FIG. 7 illustrates an example method embodiment. As illustrated, a system (such as a computer system) configured as disclosed herein can receive, from a terminal, a question (702), and determine, determining, via at least one processor of the computer system, a context of the question (704). The system can then transmit, to a large language model chatbot, the question with the context (706), and receive, from the large language model chatbot based on the question and the context, at least one function (708). In some configurations, this can also include the necessary argument(s) for the function(s). The system can then execute the at least one function (possibly using the arguments), resulting in at least one function result (710), and transmit, to the large language model chatbot, the at least one function result (712). The system can then receive, from the large language model chatbot, a natural language answer to the question based on the at least one function result (714), and transmit, to the terminal, the natural language answer (716).

In some configurations, the illustrated method can further include: retrieving, at the computer system from a database, the at least one function.

In some configurations, the illustrated method can further include: generating, via the at least one processor, an embedding based on the question; and identifying, via the at least one processor, the context based on similarity of the embedding to at least one topic, wherein the context is a most similar topic within the at least one topic. In such configurations, the similarity can be determined using a distance measurement of the embedding to the at least one topic. For example, the distance measurement can be a Cosine distance.

In some configurations, the transmitting of the question with the context to the large language model chatbot can result in a conversation, and the transmitting of the at least one function result to the large language model chatbot can append the at least one function result to the conversation.

In some configurations, the large language model chatbot is one of CHATGPT, BARD, BING, and GROK.

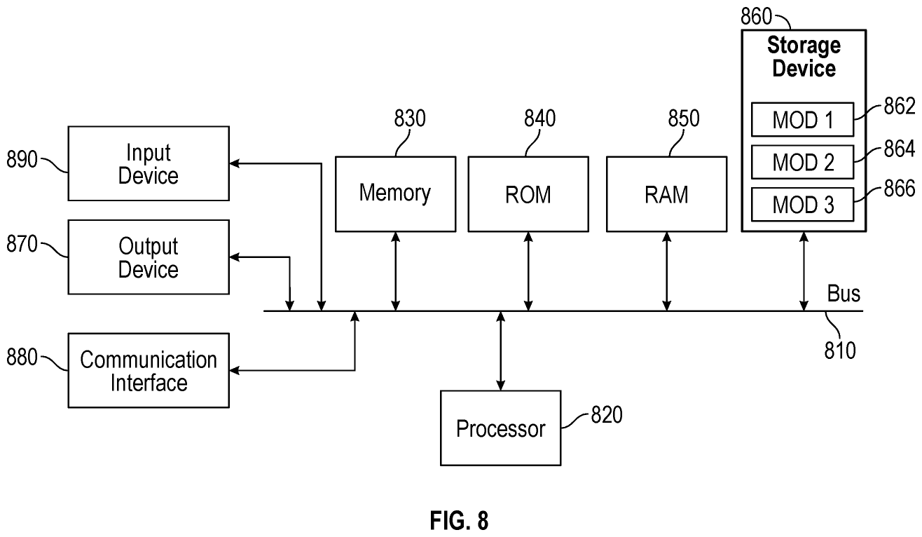

With reference to FIG. 8, an exemplary system includes a computing device 800 (such as a general-purpose computing device), including a processing unit (CPU or processor) 820 and a system bus 810 that couples various system components including the system memory 830 such as read-only memory (ROM) 840 and random access memory (RAM) 850 to the processor 820. The computing device 800 can include a cache of high-speed memory connected directly with, in close proximity to, or integrated as part of the processor 820. The computing device 800 copies data from the system memory 830 and/or the storage device 860 to the cache for quick access by the processor 820. In this way, the cache provides a performance boost that avoids processor 820 delays while waiting for data. These and other modules can control or be configured to control the processor 820 to perform various actions. Other system memory 830 may be available for use as well. The system memory 830 can include multiple different types of memory with different performance characteristics. It can be appreciated that the disclosure may operate on a computing device 800 with more than one processor 820 or on a group or cluster of computing devices networked together to provide greater processing capability. The processor 820 can include any general-purpose processor and a hardware module or software module, such as module 1 862, module 2 864, and module 3 866 stored in storage device 860, configured to control the processor 820 as well as a special-purpose processor where software instructions are incorporated into the actual processor design. The processor 820 may essentially be a completely self-contained computing system, containing multiple cores or processors, a bus, memory controller, cache, etc. A multi-core processor may be symmetric or asymmetric.

The system bus 810 may be any of several types of bus structures including a memory bus or memory controller, a peripheral bus, and a local bus using any of a variety of bus architectures. A basic input/output (BIOS) stored in memory ROM 840 or the like, may provide the basic routine that helps to transfer information between elements within the computing device 800, such as during start-up. The computing device 800 further includes storage devices 860 such as a hard disk drive, a magnetic disk drive, an optical disk drive, tape drive or the like. The storage device 860 can include software modules 862, 864, 866 for controlling the processor 820. Other hardware or software modules are contemplated. The storage device 860 is connected to the system bus 810 by a drive interface. The drives and the associated computer-readable storage media provide nonvolatile storage of computer-readable instructions, data structures, program modules and other data for the computing device 800. In one aspect, a hardware module that performs a particular function includes the software component stored in a tangible computer-readable storage medium in connection with the necessary hardware components, such as the processor 820, system bus 810, output device 870 (such as a display or speaker), and so forth, to carry out the function. In another aspect, the system can use a processor and computer-readable storage medium to store instructions which, when executed by a processor (e.g., one or more processors), cause the processor to perform a method or other specific actions. The basic components and appropriate variations are contemplated depending on the type of device, such as whether the computing device 800 is a small, handheld computing device, a desktop computer, or a computer server.

Although the exemplary embodiment described herein employs the storage device 860 (such as a hard disk), other types of computer-readable media which can store data that are accessible by a computer, such as magnetic cassettes, flash memory cards, digital versatile disks, cartridges, random access memories (RAMs) 850, and read-only memory (ROM) 840, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 800, an input device 890 represents any number of input mechanisms, such as a microphone for speech, a touch-sensitive screen for gesture or graphical input, keyboard, mouse, motion input, speech and so forth. An output device 870 can also be one or more of a number of output mechanisms known to those of skill in the art. In some instances, multimodal systems enable a user to provide multiple types of input to communicate with the computing device 800. The communications interface 880 generally governs and manages the user input and system output. There is no restriction on operating on any particular hardware arrangement and therefore the basic features here may easily be substituted for improved hardware or firmware arrangements as they are developed.

The technology discussed herein refers to computer-based systems and actions taken by, and information sent to and from, computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

Use of language such as “at least one of X, Y, and Z,” “at least one of X, Y, or Z,” “at least one or more of X, Y, and Z,” “at least one or more of X, Y, or Z,” “at least one or more of X, Y, and/or Z,” or “at least one of X, Y, and/or Z,” are intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure. For example, unless otherwise explicitly indicated, the steps of a process or method may be performed in an order other than the example embodiments discussed above. Likewise, unless otherwise indicated, various components may be omitted, substituted, or arranged in a configuration other than the example embodiments discussed above.

We claim:

1. A method comprising:
receiving, at a computer system from a terminal, a question;
determining, via at least one processor of the computer system, a context of the question;
transmitting, from the computer system to a large language model chatbot, the question with the context;
receiving, at the computer system from the large language model chatbot based on the question and the context, at least one function;
executing, at the computer system, the at least one function, resulting in at least one function result;
transmitting, from the computer system to the large language model chatbot, the at least one function result;
receiving, at the computer system from the large language model chatbot, a natural language answer to the question based on the at least one function result; and
transmitting, from the computer system to the terminal, the natural language answer.

2. The method of claim 1, further comprising:
retrieving, at the computer system from a graph, the at least one function.

3. The method of claim 1, further comprising:
generating, via the at least one processor, an embedding based on the question; and
identifying, via the at least one processor, the context based on similarity of the embedding to at least one topic, wherein the context is a most similar topic within the at least one topic.

4. The method of claim 3, wherein the similarity is determined using a distance measurement of the embedding to the at least one topic.

5. The method of claim 4, wherein the distance measurement is a Cosine distance.

6. The method of claim 1, wherein the transmitting of the question with the context to the large language model chatbot results in a conversation; and
wherein the transmitting of the at least one function result to the large language model chatbot appends the at least one function result to the conversation.

7. The method of claim 1, wherein the large language model chatbot is one of CHATGPT, BARD, BING, and GROK.

8. A system comprising:
at least one processor; and
a non-transitory computer-readable storage medium having instructions stored which, when executed by the at least one processor, cause the at least one processor to perform operations comprising:
receiving, from a terminal, a question;
determining a context of the question;
transmitting, to a large language model chatbot, the question with the context;
receiving, from the large language model chatbot based on the question and the context, at least one function;
executing the at least one function, resulting in at least one function result;
transmitting, to the large language model chatbot, the at least one function result;
receiving, from the large language model chatbot, a natural language answer to the question based on the at least one function result; and
transmitting, to the terminal, the natural language answer.

9. The system of claim 8, the non-transitory computer-readable storage medium having additional instructions stored which, when executed by the at least one processor, cause the at least one processor to perform operations comprising:
retrieving, from a graph, the at least one function.

10. The system of claim 8, the non-transitory computer-readable storage medium having additional instructions stored which, when executed by the at least one processor, cause the at least one processor to perform operations comprising:
generating an embedding based on the question; and
identifying the context based on similarity of the embedding to at least one topic, wherein the context is a most similar topic within the at least one topic.

11. The system of claim 10, wherein the similarity is determined using a distance measurement of the embedding to the at least one topic.

12. The system of claim 11, wherein the distance measurement is a Cosine distance.

13. The system of claim 8, wherein the transmitting of the question with the context to the large language model chatbot results in a conversation; and
wherein the transmitting of the at least one function result to the large language model chatbot appends the at least one function result to the conversation.

14. The system of claim 8, wherein the large language model chatbot is one of CHATGPT, BARD, BING, and GROK.

15. A non-transitory computer-readable storage medium having instructions stored which, when executed by at least one processor, cause the at least one processor to perform operations comprising:
receiving, from a terminal, a question;
determining a context of the question;
transmitting, to a large language model chatbot, the question with the context;
receiving, from the large language model chatbot based on the question and the context, at least one function;
executing the at least one function, resulting in at least one function result;
transmitting, to the large language model chatbot, the at least one function result;
receiving, from the large language model chatbot, a natural language answer to the question based on the at least one function result; and
transmitting, to the terminal, the natural language answer.

16. The non-transitory computer-readable storage medium of claim 15, having additional instructions stored which, when executed by the at least one processor, cause the at least one processor to perform operations comprising:
retrieving, from a graph, the at least one function.

17. The non-transitory computer-readable storage medium of claim 15, having additional instructions stored which, when executed by the at least one processor, cause the at least one processor to perform operations comprising
generating, via the at least one processor, an embedding based on the question; and
identifying, via the at least one processor, the context based on similarity of the embedding to at least one topic, wherein the context is a most similar topic within the at least one topic.

18. The non-transitory computer-readable storage medium of claim 17, wherein the similarity is determined using a distance measurement of the embedding to the at least one topic.

19. The non-transitory computer-readable storage medium of claim 18, wherein the distance measurement is a Cosine distance.

20. The non-transitory computer-readable storage medium of claim 15, wherein the transmitting of the question with the context to the large language model chatbot results in a conversation; and
wherein the transmitting of the at least one function result to the large language model chatbot appends the at least one function result to the conversation.
